(19) United States
(12) Patent Application Publication
(10) Pub. No.: US 2009/0090737 A1
(43) Pub. Date: Apr. 9, 2009

(54) Combined towel and soap dispenser provided for personal hygiene

(76) Inventor: Mary Bernice Franco, Rome, GA (US)

Correspondence Address: Eric R. Katz, 6115 Brook Lane, Acworth, GA, 30102, US

(21) Appl. No.: 11/973,501

(22) Filed: Oct. 9, 2007

(51) Int. Cl. A47F 1/00; B67D 1/07

(52) U.S. Cl. 221/96; 222/192

(57) ABSTRACT

A combined towel and soap dispenser is disclosed comprising a housing having a front, back, bottom, top and sides to form an enclosure for a decorative nature. A partition is provided within the housing to form an upper interior compartment for housing liquid soap and a lower interior compartment for housing a charge of folded paper towels within the housing. A dispensing slot is provided at the bottom of the housing for dispensing the folded paper towels one at a time. In addition, a soap dispenser extents out of the front of the housing for dispensing soap from the upper interior compartment of the housing.

### BACKGROUND OF THE INVENTION

1. Field of the Invention

This invention generally relates to a combined towel and soap dispensing system adapted for attachment at a bathroom sink for use in washing a person's hands and/or face and more particularly, to such a combined towel and soap dispenser for eliminating potentially unhygienic conditions that may exist when using a private personal bathroom by removing the need to use the same hand towels and soap as families, guests and/or roommates.

2. Background

Personal bathrooms are generally equipped with hygiene items such as cloth or terry towels which are typically repeatedly used and can become soiled before being replaced and bars of soap which are handled each time a person needs to wash their dirty hands. The soap bars can make a mess around the sink area due to the constant exposure to moisture or pooled water. Problems still arise if the soap bar is replaced with a liquid soap container due to spillage or dripping. As a result, a visitor to the bathroom can be confronted with a soiled hand towel and/or soap that is messy or dirty from prior use making for unhygienic conditions.

It is known to combine fluid and paper towel sheet products for use in cleaning applications. For example, U.S. Pat. No. 4,516,676 is typical of such combinations and discloses a window cleaning kit that contains a spray liquid applicator, a paper towel dispenser and an absorbent scrubbing element in a single self contained unit. Typically, these types of combination comprise a spray bottle surrounded by a roll of paper towels which not particularly well suited for use in washing ones hands.

Also known is the dispensing device disclosed by U.S. Pat. No. 2,789,725 which comprises an arrangement for holding a stack of folded paper towels and a liquid for wetting the paper towels for cleaning purposes. This arrangement is not well suite for use in hand washing since the liquid dispense is inconveniently located at the top of the device and the paper towels are loaded vertically, making it tricky to refill without the towels falling out before the front of the device is replaced.

In view of the foregoing, there is a need for a combined soap and towel dispenser specifically adapted for personal hygiene which can be attached at a bathroom sink and is easy to use and service.

### SUMMARY OF THE INVENTION

Accordingly, it is an object of the present invention to provide a combined towel and soap dispensing system that overcomes the deficiencies of the prior art.

Another object of the present invention is to provide a combined towel and soap dispenser which eliminated potentially unhygienic conditions found at a personal and private bathroom by eliminating the need to re-use the same hand towels and soap bars.

Yet another object of the present invention is to provide a combined towel and soap dispenser which is easy to use and service.

Still another object of the present invention is to provide a combined towel and soap dispenser that removes messy and potentially soiled soap bars and liquid soap containers off the of the sink surface or counter.

Yet another object of the present invention is to provide a combined towel and soap dispenser that permits the user to select a personally preferred brand of liquid soap.

A further object of the present invention is to provide a combined towel and soap dispenser this decorative in nature as well as functional.

An additional object of the present invention is to provide a combined towel and soap dispenser that reduces clutter and mess around a bathroom sink to provide an improved hygienic environment.

These and other objects, advantages and features of the present invention are achieved, according to one embodiment of the present invention, by a combined towel and soap dispenser comprising a housing having a front, back, bottom, top and sides to form an enclosure for a decorative nature. A partition is provided within the housing to form an upper interior compartment for housing liquid soap and a lower interior compartment for housing a charge of folded paper towels within the housing. A dispensing slot is provided at the bottom of the housing for dispensing the folded paper towels one at a time. In addition, a soap dispenser extents out of the front of the housing for dispensing soap from the upper interior compartment of the housing.

In a preferred embodiment of the present invention, the liquid soap is contained in a removable and refillable reservoir so that any desired type of liquid soap can be used with the dispenser. In addition, the interior partition forms a shelf on which the soap reservoir is supported. The partition is also easily removed to permit cleaning of the interior of the housing.

The lower compartment of the housing is configured so that the charge of folded paper towels is disposed horizontally within the lower compartment for easy loading. The soap dispenser preferably comprises a hand operate pump that attaches to the soap reservoir and extends through the front of the housing. The soap pump is preferably attached to the soap reservoir by a threaded arrangement so that it can be easily removed for cleaning or replacement.

The front of the housing is formed by a pair of clam shell top and bottom covers that are pivotally mounted to the side of the housing and moveable between open and closed positions. The clam shell top cover is held in place in the closed position by gravity and is provided with a centrally located slot at the bottom of the cover for accommodating the soap pump sticking out from the soap reservoir. The claim shell bottom cover is held in place in the closed position by a pair of detents which operate to lock the bottom cover in the closed position.

The back of the housing is provided with an attachment arrangement for attaching the dispenser to a surface near the sink of a bathroom or the like. The attachment arrangement includes both mechanical and adhesive fasteners as will be more fully described below

### BRIEF DESCRIPTION OF THE DRAWINGS

FIG. 1 is a perspective view of one embodiment of the combined towel and soap dispenser of the present invention;

FIG. 2 is an exploded perspective view of the dispenser of FIG. 1 illustrating the structural configuration of the interior compartments and components of the present invention;

FIG. 3 is a perspective view of the dispenser of FIG. 1 with the calm shell covers in the open position illustrating the arrangement of the components of the present invention in their operative positions; and

FIG. 4 is a rear planar view of the dispenser of FIG. 1 illustrating the attachment arrangement for the combined towel and soap dispenser of the present.

### DETAILED DESCRIPTION OF THE PREFERRED EMBODIMENT(S)

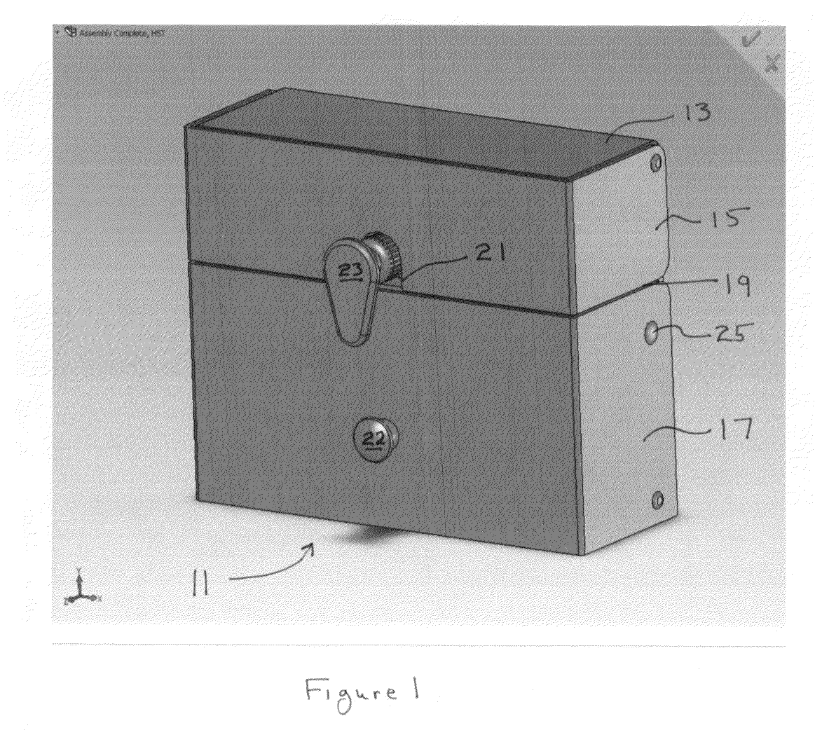

The combined towel and soap dispenser of the present invention in its preferred embodiments comprise a wall unit having a substantially rectangular shape as shown in FIG. 1. The wall unit is constructed from, for example, hard plastic materials such as, for example, ABS/PC plastic with a wall thickness of about 0.125 inches and preferably having solid colors such as, for example, black, white, ivory, pink, burgundy, gold, yellow, red, brown, chocolate, green or blue and shades thereof. In addition, the present invention can be made of metal materials such as brushed nickel, brass and/or chrome or simulated metal products providing similar finishes. The dimensions of the wall unit are, for example, about 9½ inches wide by about 8 inches length and deep enough to hold a charge of folded towels in a horizontal orientation, for example, about 2 inches deep.

Although the embodiment of FIG. 1 is shown having an oblong horizontal configuration, it should be understood by those of ordinary skill in the art that the soap and towel dispensing unit of the present invention also comprises an oblong vertically oriented wall unit having the same construction and elements as those described in reference to FIG. 1.

Referring to FIG. 1, one embodiment of the combined soap and towel dispenser of the present invention is generally illustrated at 11 wherein the wall unit is configured with a width greater than it height having the general dimensions discussed above. The dispenser 11 comprises a decoratively colored housing 13 made of any suitable material. A front 15 of the housing 13 is formed by a pair of clam shell top and bottom covers, 15, 17 respectively that are pivotally mounted to the sides 19 of the housing 13 so as to be movable between open and closed positions.

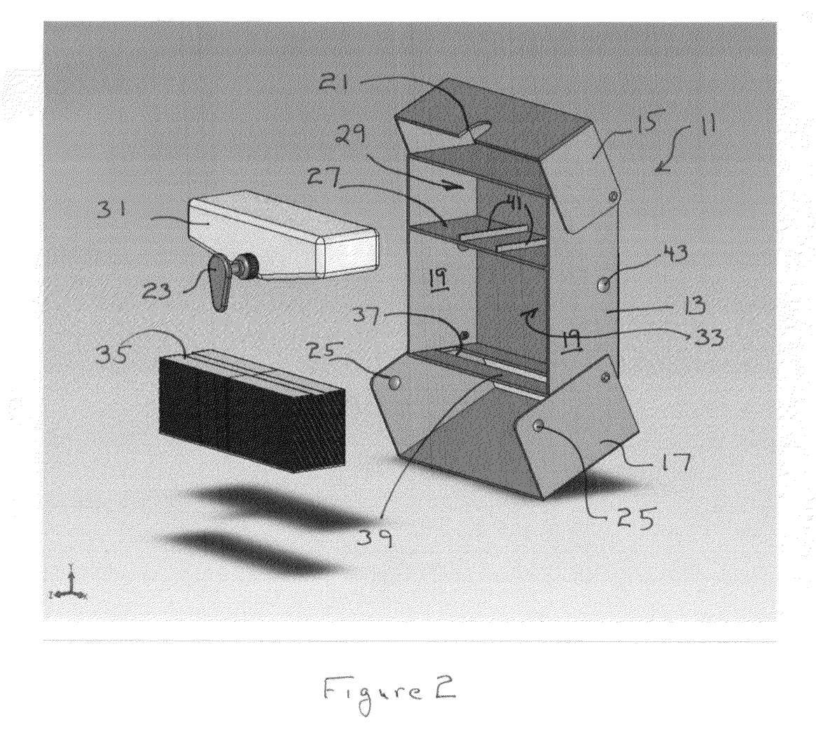

The clam shell top cover 15 is held in place in the closed position by gravity and is provided with a centrally located slot 21 at the bottom of the cover 15 for accommodating a soap pump 23 sticking out from a soap reservoir (not shown) position in the interior of the housing 13. The claim shell bottom cover 17 is held in place in the closed position by a pair of detents 25 which operate to lock the bottom cover in the closed position to the sides 19 of the housing 13 as better seen in FIG. 2. In addition, the clam shell bottom cover 17 is provided with a knob 22, a simple tug of which overcomes the detent lock and release the cover 17 from its locked position.

FIG. 2 shows the dispenser 11 of FIG. 1 with the clam shell covers 15, 17 in the open position. An interior partition 27 is provided within the housing 13 to form an upper interior compartment, generally indicated at 29, for housing a liquid soap reservoir 31 which is refillable with liquid soap and a lower interior compartment, generally indicated at 33 for housing a charge of approximately 50 to 100 paper towels 35. The dimensions of the paper towels 35 are, for example, about 9⅜ inches wide by about 9½ inches in length stacked in an interlaced folded style so as to be sequentially dispensed through slot 37 provided in the bottom 39 of the housing 13.

The partition 27 is located about 2½ inches from the top of the housing and can be integrally molded as a part of the housing 13 or preferably comprises a clear plastic shelf, the edges of which are slideably received by a pair of brackets respectively form on the interior of each of the sides 19 of the housing 13. Each bracket forms a slot for respectively receiving one of the side edges of the partition 27 to permit the unimpeded insertion and removal of the clear plastic shelf 27 to facilitate easy cleaning of the interior of the housing 13.

As seen in FIG. 2, the soap reservoir 31 has a v-shaped bottom which, with the assistance of gravity, draws the liquid soap towards the intake orifice (not shown) of the hand pump 23 which is preferably located at the point of the v. The soap reservoir 31 is made, for example of PP plastic that is blown molded. The soap reservoir 31 is supported by the shelf 27 and its V-shaped bottom cooperates with a pair of rails 41 protruding upward from a top surface of the shelf 27 which slideably receive and position the reservoir 31 centrally within the upper interior compartment 29.

The soap reservoir 31 is sized to contain, for example, on the order of 10 to 12 oz of liquid soap. The hand pump 23 is positioned on the front of the reservoir 31 and is attached thereto by a threaded collar which cooperates with a threaded coupling forming an opening in the front of the reservoir 31 for receiving the hand pump 23. The hand pump 23 and its threaded collar are preferably the same color as the wall unit and is constructed from, for example plastic and is non-drip. In addition, each side 19 of the housing 13 is provided with an indentation or recess 43 that mates with the detents 25 of the clam shell bottom cover 17 to lock the cover 17 in the closed position.

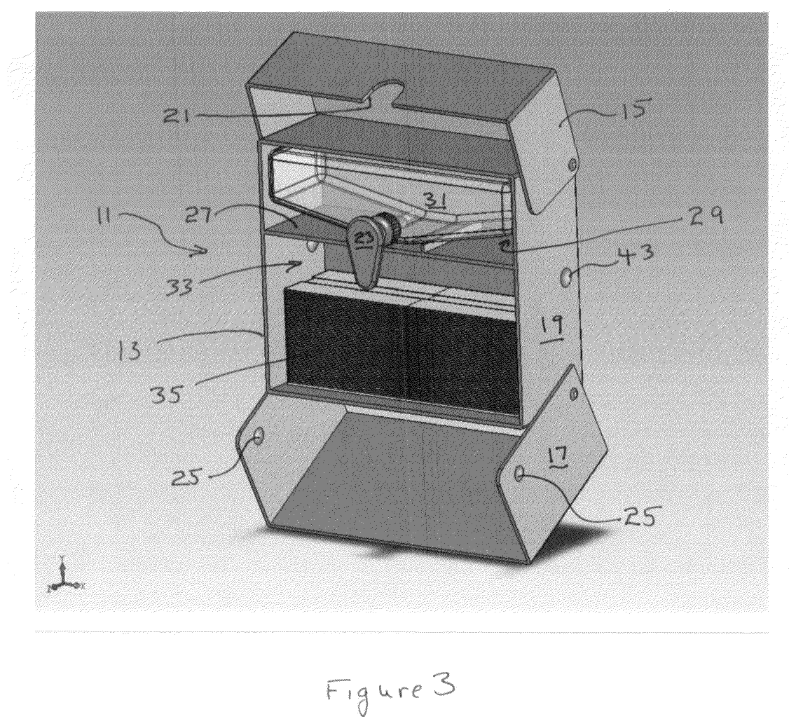

FIG. 3 is a perspective view illustrating the components of the present invention in their operative positions. To refill the soap reservoir 31, the clam shell top cover 15 is lifted as shown in FIG. 3 and slid out of the top interior compartment 29. The hand pump 23 is unscrewed from the reservoir 31 which is then refilled with the liquid soap of choice. Once the reservoir is filled, the hand pump 23 is rethreaded onto the reservoir 31 and inserted back into interior compartment 29. Rails 41 properly position the reservoir and hand pump combination so that when the front cover is closed the slot 21 slides over the pump handle sticking out of the reservoir for a good clean fit.

To refill the paper towels, the knob 22 can be tugged to open the lower cover 17 or using both hands, one can pry the detents 25 of the lower cover 17 out of recesses 43 and lower the cover 17 to the open position. The stack of paper towels 35 are then placed into the lower interior compartment 33 so that a single sheet of paper towel extends out of the slot in the bottom of the housing 13.

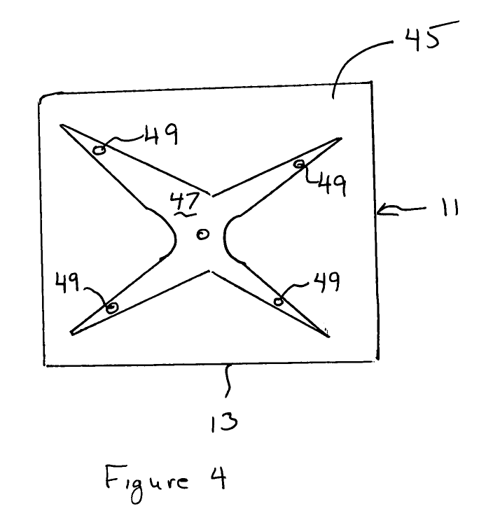

FIG. 4 illustrates the anchoring arrangement for attaching the wall unit to a wall. The back 45 of the housing 13 is provided with a raised surface 47 generally in form of an X on which an adhesive resides. Five holes 49 are provided through the back 45 for receiving anchors or attaching the dispenser 11 to the wall. The anchors comprise, for example, self drilling drywall anchors and/or screws.

Although the present invention has been described in terms of specific exemplary embodiments, it will be appreciated that various modifications and alterations might be made by those skilled in the art without departing from the spirit and scope of the invention as specified in the following claims.

What is claimed is:

1. A combined towel and soap dispenser comprising:
a housing having a front, back, bottom top and sides which form an enclosure;
a partition within the housing forming an upper interior compartment for housing liquid soap and a lower interior compartment for housing a charge of folded paper towels within the housing;
a dispensing slot in the bottom of the enclosure for dispensing paper towels from the lower interior compartment of the housing;
a soap dispenser at the front of the housing and connected to the soap in the upper interior compartment of the housing for dispensing soap therefrom.

2. A combined towel and soap dispenser according to claim 1, wherein the liquid soap is housed in the upper compartment is contained in a removable and refillable soap reservoir.

3. A combined towel and soap dispenser according to claim 2, wherein the soap reservoir has a substantially v-shaped bottom.

4. A combined towel and soap dispenser according to claim 2, wherein the partition forms a shelf for supporting the soap reservoir.

5. A combined towel and soap dispenser according to claim 4, wherein the partition is provided with a pair of rails that cooperate with the v-shaped bottom of the soap reservoir to position the reservoir within the interior compartment at a predetermined position.

6. A combined towel and soap dispenser according to claim 1, wherein the partition is removable for easy cleaning of an interior of the housing.

7. A combined towel and soap dispenser according to claim 1, wherein the lower compartment is configured to receive and support a charge of folded paper towels disposed horizontally within the lower compartment.

8. A combined towel and soap dispenser according to claim 1, wherein the soap dispenser is a hand operated pump.

9. A combined towel and soap dispenser according to claim 2, where in the soap dispenser is a hand operated pump and the pump and reservoir have a complementary threaded arrangement for removeably connecting the pump to the soap reservoir.

10. A combined towel and soap dispenser according to claim 1, wherein the front of the enclosure has open and closed position to provide access to the interior of the housing.

11. A combined towel and soap dispenser according to claim 1, wherein the back of the housing has means for attaching the dispenser to a surface.

12. A combined towel and soap dispenser according to claim 11, wherein the surface is a wall.

13. A combined towel and soap dispenser according to claim 11, wherein the attachment means includes both mechanical and adhesive fasteners.
